(19) United States
(12) Patent Application Publication
(10) Pub. No.: US 2020/0047984 A1
(43) Pub. Date: Feb. 13, 2020

(54) CAPSULE, SYSTEM AND METHOD FOR PREPARING A BEVERAGE

(71) Applicant: KONINKLIJKE DOUWE EGBERTS B.V., Utrecht (NL)

(72) Inventors: Andrew Michael HALLIDAY, Alderminster (GB); Glen Andrew OLIVER, Banbury (GB)

(73) Assignee: KONINKLIJKE DOUWE EGBERTS B.V., Utrecht (NL)

(21) Appl. No.: 16/340,088

(22) PCT Filed: Oct. 6, 2017
(86) PCT No.: PCT/NL2017/050661

§ 371 Date: Apr. 5, 2019

(30) Foreign Application Priority Data
Oct. 7, 2016 (NL) 2017586

(51) Int. Cl. B65D 85/804; A47J 31/40; A47J 31/36; A23F 5/26

(52) U.S. Cl. CPC B65D 85/8043; A47J 31/407; A47J 31/3633; A23F 5/262; A47J 31/3628

(57) ABSTRACT

In a capsule containing a substance constituted by a mass of loose, solid particles, for the preparation of a potable beverage by extracting and/or dissolving the substance by means of supplying a fluid under pressure into the capsule, a screen, permeable to water and impermeable to a predominant portion of particles of the substance is positioned between the substance and the bottom. The screen is provided with a plurality of passages dimensioned so that at least a fraction of the substance can pass through the passages in solid form. A beverage brewing system comprising such a capsule and a method of use of such a capsule are described as well.

### FIELD AND BACKGROUND OF THE INVENTION

The invention relates to a capsule according to the introductory portion of claim 1. Such a capsule is known from European patent application 0 468 079.

In practice, such capsules are mostly arranged and used for extracting coffee, by pressing an injection fluid such as hot water under pressure through powder obtained by grinding roasted coffee beans. However, the substance, which may be in the form of for instance granules, chips or flakes, may also be constituted by or contain constituents that are to be dissolved anchor entrained, such as sugar or milk powder. Substances to be extracted may also be of other types than coffee, such as tea or herbs.

Widely used in the market are capsules of which the capsule body is of aluminium or plastic and of which the open end is sealed-off by a thin sheet, usually of aluminium. The closed end of the capsule body is typically referred to as the bottom. The coffee machine has a housing in which a major portion of the capsule body can be received and a closing member. The housing and/or the closing member is/are movable relative to the other between an operating position in which the flange of the capsule is clamped between the housing and a closing member and a transfer position leaving an opening through which a used capsule can be removed from the housing and a fresh capsule can be positioned in the housing. Piercing elements are provided which in use pierce a bottom portion of the capsule body inside the housing.

When pressurised fluid is fed into the housing, it penetrates the capsule through the holes made by the piercing element, and causes an increase in the internal pressure which causes the cover to be torn, for instance with assistance of piercing members of the closing member. Then, a flow of water is pressed into the substance and brewed beverage exits the capsule and guided to a receptacle of the user outside of the machine. The cover may also be to some extent open prior to injection of the pressurized fluid, for instance if the capsule is packaged in a barrier material for retaining flavours, which barrier material is to be removed prior to use.

European patent 1 165 398 discloses a capsule which comprises, in the dish of the capsule at the level of the bottom of the capsule, a means guaranteeing retention of solid substance when it is open, so that substance does not pass through the pierced openings while or after the piercing elements are retracted out of the capsule. This means may be a fabric which may be pierced easily by means of a perforating needle and, at the end of the extraction, its flexibility and elasticity allow the pierced openings to close again when said needle is removed from the cartridge so that the grounds do not exit the capsule. According to another solution a non-return valve is adhesively bonded to the bottom. This valve may have a cross-shaped cut-out which allows satisfactory opening and satisfactory re-closing when the extraction needle is inserted and removed.

WO2010/115970 discloses a capsule with a filter downstream of the substance in the capsule, which filter has pyramid shaped openings that are dimensioned to prevent the powdered substance from passing through the openings.

### SUMMARY OF THE INVENTION

It is an object of the present invention to provide a capsule which can be manufactured in a simple manner at low costs and which is further improved with respect to processing of the substance into a beverage of high organoleptic and visual quality.

According to the invention, this object is achieved by providing a capsule according to claim 1.

Since the passages are dimensioned to allow particles of the substance to pass through in solid form, particles may pass to the outside of the capsule body after the piercing elements have been retracted and pressure from the outside is no longer applied to the capsule. Amounts of substance flowing out will show the user the substance from which the beverage has been brewed, which enhances the similarity to brewing coffee in a manually filled brewing apparatus such as a conventional espresso machine, so that the real coffee making experience is improved. Thus by doing exactly the opposite as proposed in the previously mentioned European patent 1 165 398, an important advantage is realised. Moreover a second advantage is realised. Because the screen is provided with a plurality of passages dimensioned so that at least a fraction of the substance can pass through in solid form, water distribution over the substance, through which the water is pressed, is guided effectively, but incurs less flow resistance than a screen of the same water permeable material without passages dimensioned so that at least a fraction of the substance can pass through in solid form. The relatively large passages provide distributed areas where flow resistance is particularly low. In particular the screen may be made from a filter material provided with the plurality of passages. More particularly the filter material may be a non-woven material. It shows that such a screen provides an excellent water distribution over the substance bed (in particular ground coffee bed) so that extraction is improved. Without being bound to theory, it is expected that the improved extraction is obtained by a combination of the porosity of the filter material on the one hand and the passages in the filter material on the other hand.

The openings may for instance have a diameter of 1-4 mm. The diameter of the screen may for instance be 20-40 mm, for example 22-30 mm. The diameter of the bottom of the capsule may for instance be 20-40 mm, for example 22-30 mm. The diameter of the screen may be about the same as (e.g. 95-105% of) the diameter of the bottom at the inside of the capsule. The screen may for instance be provided with 4-30 passages, preferably about 15-25 passages. The screen area including a pattern of the passages may cover 50-100% of the bottom, the remainder of the screen area being free of a pattern of the passages. In a practical embodiment the screen is provided with 15-18 passages each having a diameter of 1.5-2.5 mm, preferably 1.6-2.2 mm, more preferably of 1.6-1.8 mm.

The screen material may for instance have a weight of 20-200 g/cm², preferably 40-100 g/cm². The screen material may for instance have a thickness of 0.1-1 mm, preferably 0.2-0.5 mm. The screen material (without the passages) may for instance have an air permeability between 500 and 3000 l/(m²s) at a pressure drop of 100 Pa over the screen material, preferably between 1000 and 1500 l/(m²s) at a pressure drop of 100 Pa over the screen material.

In general, as a result of the relatively low pressure loss at the screen, the screen according to the invention allows water to be distributed over flow paths including flow paths of a relatively great length, where pressure drop per unit of flow distance would otherwise be relatively low. Also any tendency of water to pass along flow paths circumventing the screen or to pass through a hole pierced in the screen is reduced because the pressure drop over the screen is lowered. Reducing the pressure drop over the screen further provides the advantage that more of the overall pressure drop is left as a net pressure drop over the substance, so that extraction can be more intensive.

Particular elaborations and embodiments of the invention are set forth in the dependent claims. The invention may also be embodied in a system according to claim 23 and in a method for brewing a beverage according to claim 25.

Further features, effects and details of the invention appear from the detailed description and the drawings.

### BRIEF DESCRIPTION OF THE DRAWINGS

FIG. 1 is a perspective cross-sectional view of a first example of a capsule according to the invention;

FIG. 2 is a schematic cross-sectional side view of the capsule according to FIG. 1 positioned between a housing and a closing member of a coffee making machine;

FIG. 3 is a perspective cross-sectional view of a second example of a capsule according to the invention;

FIG. 4 is a top plan view of a screen of a third example of a capsule according to the invention;

FIG. 5 is a top plan view of a screen of a fourth example of a capsule according to the invention; and

FIG. 6 is a top plan view of a screen of a fifth example of a capsule according to the invention.

### DETAILED DESCRIPTION

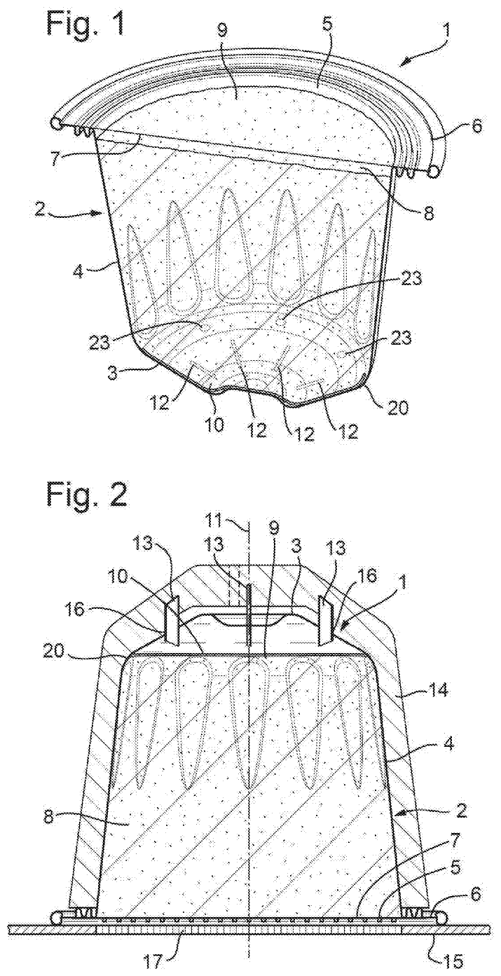

In FIGS. 1 and 2 a first example of a capsule 1 according to the invention is shown. The capsule 1 has a capsule body 2 having a bottom 3, a side wall 4, an end 5 opposite of the bottom 3 and a flange 6 extending outwardly from the side wall 4 and around the open end 5. A cover 7 of the capsule is attached to the outwardly extending flange 6 and hermetically closes off the end 5 of the capsule body 5 opposite of the bottom 3. For illustrative purposes, the cover 7 is shown as a transparent member. The cover may also be open to some extent, for instance in an embodiment in which the capsule is packaged in a flavour retaining barrier that is to be removed prior to use and in which the cover does not have to be opened further to allow the brewed beverage to flow through.

The capsule body 2 and the cover 7 bound a capsule chamber 8. The capsule chamber 8 contains a substance 9 constituted by a mass of loose, solid particles, for the preparation of a potable beverage by extracting and/or dissolving the substance by means of supplying an injection fluid under pressure into the capsule.

In this example and also in other embodiments of the invention, the substance can for instance be ground, roasted coffee beans, but may also be another substance from which constituents are to be extracted and/or which is to be dissolved and/or emulsified when pressurised injection liquid such as hot water is passed through, for instance tea, milk powder and/or sugar, or dried soup. The substance may for instance be 5-40 grams, preferably 5-30 grams, more preferably 5-14 grams of roasted and ground coffee.

For compatibility with widely used coffee machines, it is generally preferred that the capsule is in accordance with one or more of the following features, wherein dimensions are to be selected within these ranges depending on the type of coffee making machine in which the capsule is to be used:
the outer diameter of the outwardly extending flange is approximately 37-45 mm,
the diameter of the bottom of the capsule is about 23-30 mm,
an inner edge of a curled outer edge of the outwardly extending flange has a radius about the central capsule body axis of at least 32-42 mm,
the curled outer edge of the outwardly extending flange has a largest dimension of about 1.2-1.6 mm,
the inner diameter of the free end of the side wall of the capsule body is about 29-35 mm,
the distance between the free end of the side wall of the capsule body and an outermost edge of the outwardly extending flange is about 3.5-5 mm,
a height of the capsule body is about 28-40 mm,
the capsule body is truncated, wherein preferably the side wall of the capsule body encloses an angle with a line transverse to the central capsule body axis of about 94-98°,
the bottom of the capsule body has a largest inner diameter of about 23-29 mm,
the bottom of the capsule body is truncated, preferably having a bottom height of about 4-7 mm and wherein the bottom further has a generally flat central portion opposite the cover having a diameter of about 8-11 mm,
the height of the sealing member portion to be contacted first by the free end of the enclosure member when the enclosure member is closed is at least about 0.1 mm, more preferably at least 0.2 mm and most preferably at least 0.8 mm and at most 3 mm, more preferably at most 2 mm and most preferably at most 1.2 mm.

The wall thickness of the cover (preferably made of aluminium) is preferably smaller than the wall thickness of the capsule body, which may for instance be of aluminium or plastic material, such that the cover can be caused to open with assistance of a pressure applied to the capsule chamber, for instance by causing the aluminium cover to tear open on a closing member of the beverage preparation device, such as an extraction plate of the beverage preparation device, under the influence of fluid pressure in the capsule.

In the capsule chamber 8, a screen 10, of a material permeable to water and impermeable to a predominant portion of the particles of the substance 9 is arranged. The screen 10 is positioned between the substance 9 and the bottom 3 of the capsule and has a centre approximately coaxial with a centre line 11 of the capsule 1. In this example, the screen 10 is attached to the capsule body 1 along attachment zones 12 spaced from the centre 11 and circumferentially spaced from each other. The screen 10 may also be arranged loosely in the capsule, without being attached to the capsule body 2.

The circumferentially distributed attachment zones 12 keep a peripheral portion of the screen 10 in position in the capsule 1, yet interfere relatively little with liquid flow through the screen 10, so that a relatively large portion of the screen 10 up to its peripheral edge is available for liquid to pass through. Also, the screen 10 reliably keeps the piercing elements 13 (FIG. 2) separated from the substance, since a portion of the screen 10 centrally of the attachment zones 12 is left free to move away from the bottom 3 when the piercing elements 13 enter the capsule chamber 8 through perforations pierced thereby in the bottom 3 of the capsule body 2. It may however also be provided that the piercing elements do pierce the screen or that a passage is provided in the screen through which a tip end of the piercing element passes when it is pierced into the capsule.

The screen 10 is provided with a plurality of passages 23 dimensioned so that at least a fraction of the substance 9 can pass through the passages 23 in solid form. The fraction of the substance 9 that can pass (i.e. is small enough to pass) through the passages may for instance be the smallest 10%, 30% or 50% of the substance 9. It may also be provided that all particles of the substance are in principle capable of passing through the passages or that some of the passages allow a larger fraction of the substance to pass through than other ones of the passages. Also, even though particles are in principle capable of passing through the passages, in practice most of the substance, and also most of the fraction that can pass through the passages, will in fact not pass through the passages. This is because, after brewing, most of the substance is not exposed to backflow of sufficient magnitude to entrain these particles through the passages and because particles tend to cling to each other after having been wetted. However, it has been found that a significant amount of particles does pass through the passages and even to the outside of the capsule, so that after brewing a sample of the substance from which the beverage is brewed is visible and can easily be smelled by the consumer.

Moreover, these passages 23 allow water distribution over the substance 9, through which the water is pressed with a smaller pressure drop over the screen, because the relatively large passages provide distributed local areas where flow resistance is particularly low. This allows water to be distributed over flow paths including flow paths of a relatively great length, where pressure drop per unit of flow distance would otherwise be relatively low. Also any tendency of water to pass along flow paths circumventing the screen 10 or to pass to a relatively large extent through a hole pierced in the screen is reduced, because the pressure drop over the screen 10 is lowered. Reducing the pressure drop over the screen 10 further provides the advantage that more of the overall pressure drop is left as a net pressure drop over the substance 9, so that extraction can be more intensive.

For leaving a large peripheral portion of the screen 10 free for the liquid to pass through spacings in circumferential sense between successive attachment zones 12 preferably leave open at least 30% or, in order of increasing preference, 40%, 50%, 60% or 70% of a circumferential zone in which the attachment zones 12 are located.

To allow the screen 10 to be displaced by the piercing elements 13 easily, without being pierced thereby, the screen 10 is preferably made of flexible material, such as paper, plastic film, or fibre material in the form of a woven, non-woven or knitted structure. Good brewing results at low costs can be achieved if the screen 10 is of filter paper. If the filter paper contains thermoplastic constituents such as fibres and/or binder material, these can be used for sealing to the capsule body in the attachment zones, as will be described in more detail.

For allowing the screen 10 to be displaced by the piercing elements 13 easily, it is also advantageous if all the attachment zones are distributed along a periphery of the screen element only.

In FIG. 2 also relevant parts of a coffee machine, which, together with the capsule 1, form a beverage brewing system, are shown. These parts include a housing 14 in which a major portion of capsule body 2 can be received and a closing member 15 with passages 17 for allowing a prepared beverage to flow away from the capsule 1. The housing 14 and/or the closing member 15 is/are movable relative to the other between an operating position in which the flange 6 of the capsule 1 is clamped between the housing 14 and the closing member 15 and a transfer position leaving an opening through which a used capsule 1 can be removed from the housing 14 and a fresh capsule 1 can be positioned in the housing 14. The piercing elements 13, which are arranged for, in use, piercing a bottom portion 3 of the capsule body 2 inside the housing 14 in several piercing locations 16 (in principle a single piercing element for piercing in a single location would be possible as well; in this example three piercing elements are provided which lay on a circle such that each of the piercing elements pierces the capsule just outside a central part of the bottom). Such coffee machines are commercially available and therefore not described in more detail.

In operation, the capsule 1 is positioned in the housing 14 and clamped between the housing 14 and the closing member 15 with perforations 17 for allowing brewed beverage outputted through the cover 7 to flow away from the capsule 1. A bottom portion 3 of the capsule body 2 inside the housing 14 is pierced and pressurised injection fluid, such as hot water, is fed into the housing 14, causing the injection fluid to penetrate the capsule 1 through at least one hole 16 pierced in the bottom 3. The hole may also have been provided in the bottom prior to placing the capsule in the housing, e.g. during manufacturing.

Then, the cover 7 is caused to be torn, preferably under the influence of fluid pressure in the capsule 1 and a flow of the injection fluid is passed at least partially through the screen 10, into and through the substance and through the cover so that a brewed beverage exits the capsule; and the brewed beverage is guided to a receptacle.

Since the passages 23 are dimensioned to allow particles of the substance 9 to pass through in solid form, an appreciable amount of the particles will pass to the outside of the capsule body 2 after the piercing elements 13 have been retracted and pressure is no longer applied to the capsule 2. Thus, the user can see and better smell some of the substance from which the beverage has been brewed, which enhances the similarity to and association with brewing coffee in a manually filled brewing apparatus such as a conventional espresso machine that has to be filled with ground coffee manually.

For radial distribution of water, it is preferred that at least some of the passages 23 are located peripherally of the location or locations of the piercings 16 or of openings pre-fabricated in the bottom.

In the system according to the invention, the attachment zones 12 are located peripherally of the piercing location or piercing locations 16 only. Thus, it is ensured that the piercing elements contact the screen 10 in an area surrounded by and located centrally relative to the attachment zones 12, so that the screen 10 can on the one hand move along with the tips of the piercing elements 13 contacting the screen 10 while on the other hand being retained in place in several positions surrounding the piercing elements 13, so that substance 9 is reliably prevented from reaching piercing locations 16, by circumventing the screen 10 or by being entrained with a piercing element 13 as it is retracted.

For this purpose, it is moreover preferred that the attachment zones 13 are all arranged at a distance from the centre 11 of more than 60% or, more preferably, more than 70% of the radial size of the screen 10 in a direction from the centre 11 to the respective attachment zone 13. Also for this purpose, and for ease of manufacturing, it is preferred that the number of attachment zones 12 is less than 25 and, more preferably, less than 20 or 15. Thus the screen is attached to the capsule only at the attachment zones which are spaced from the centre and circumferentially spaced from each other. The screen is not attached to a centre area of the bottom. The screen is arranged to move away from the centre area of the bottom under influence of fluid injected via openings in the bottom which openings are created by means of an apparatus wherein the capsule is positioned for brewing coffee and/or under influence of piercing elements by means of which, in use, openings are pierced in the bottom of the capsule for injecting fluid into the capsule.

A particularly reliable fixation along the periphery of the screen 10 can be achieved if, as in the present example, the attachment zones 12 are located directly adjacent to a transition 20 from the bottom 3 to the side wall 4. For reliable fixation, it is moreover preferred that the number of attachment zones is at least three and, more preferably, at least four, five or six.

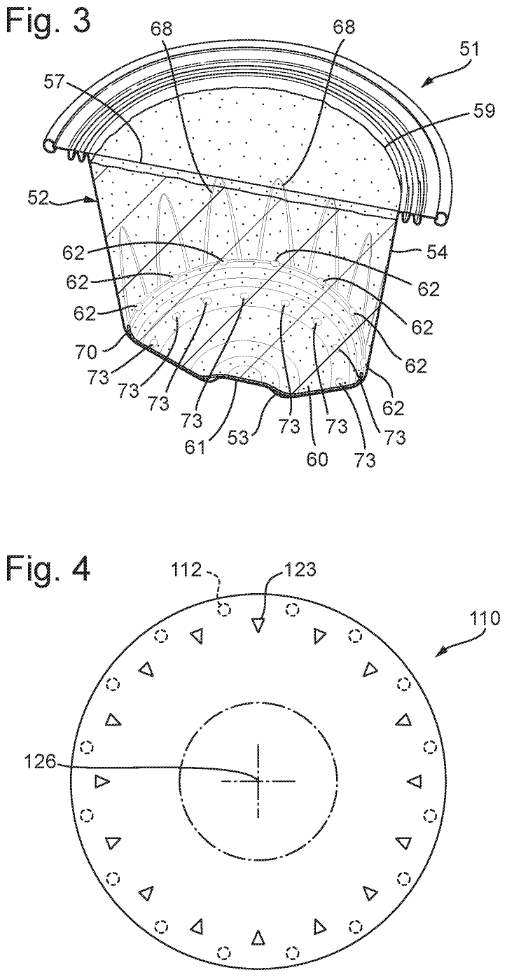

In FIG. 3 a second example of a capsule 51 according to the invention is shown. In principle, only features of this capsule 51 that differ significantly from the capsule 1 shown in FIGS. 1 and 2 are described. For illustrative purposes, the cover 57 in FIG. 3 is shown as a transparent member.

In this capsule 51, the attachment zones 62 are at least partially located in a transition 70 from the bottom 53 to the side wall 54. This allows the screen 60 to be attached further from the centre 61 of the capsule 51. In the present example, this is taken to an extreme by arranging the attachment zones 62 in end portions near the bottom 53 of flutes 68 bulging outwardly of the general conical shape of the sidewall 54.

In this example, the passages 73 through the screen 60 that are large enough to allow particles of the substance 59 to pass through in solid form are arranged in a single circle instead of in two concentric circles as the example shown in FIGS. 1 and 2.

In FIG. 4 yet another example of a screen 110 for a capsule according to the invention is shown. In this example, the passages 123 are not of a circular shape, but of an elongate, triangular shape. By providing elongate passages, such a slots, oval passages or rhombus-shaped passages, water, relatively large areas of reduced resistance are provided, without proportionally allowing more of the substance to pass through. The attachment zones 112 are arranged in an annular zone outside of the annular zone in which the passages 123 are located. Thus, even if the position of the attachment zones 112 is fixed in rotational sense about the centre 126 of the screen 110, the screen can be attached to the capsule body in any position in rotational sense about that centre, because the attachment zones are always outside of the passages 123.

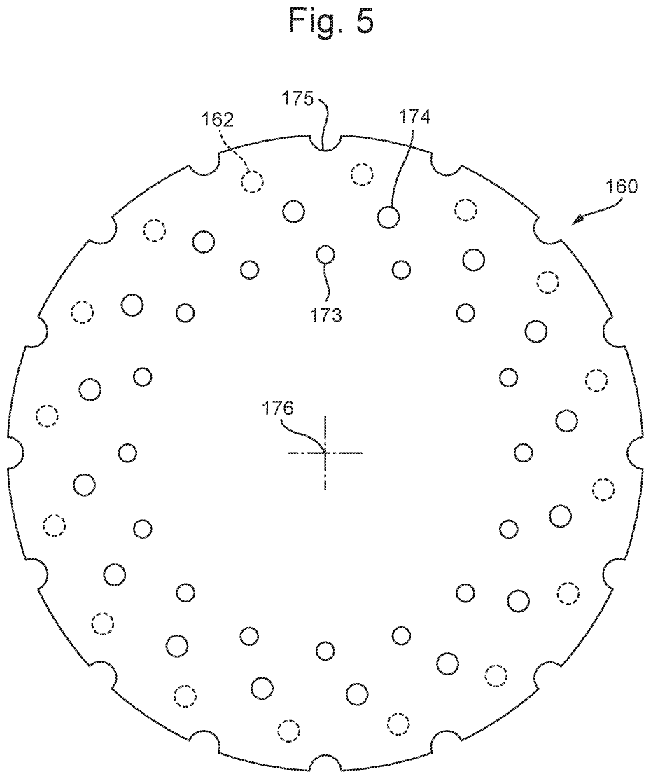

In FIG. 5, a further example of a screen 160 for a capsule according to the invention is shown. In this example, the passages 173, 174, 175 are arranged in three annular zones concentric around the centre 176 of the screen 160. The passages 173, 174 in the inner rings are formed by openings in the material of the screen 160, which openings are circumferentially bounded by material of the screen 160. The passages 175 in the outer annular zone are formed by bays in the outer circumferential edge of the screen 160. The bays form areas of reduced flow resistance where water can pass between the perimeter of the screen 160 and the side wall of the capsule body.

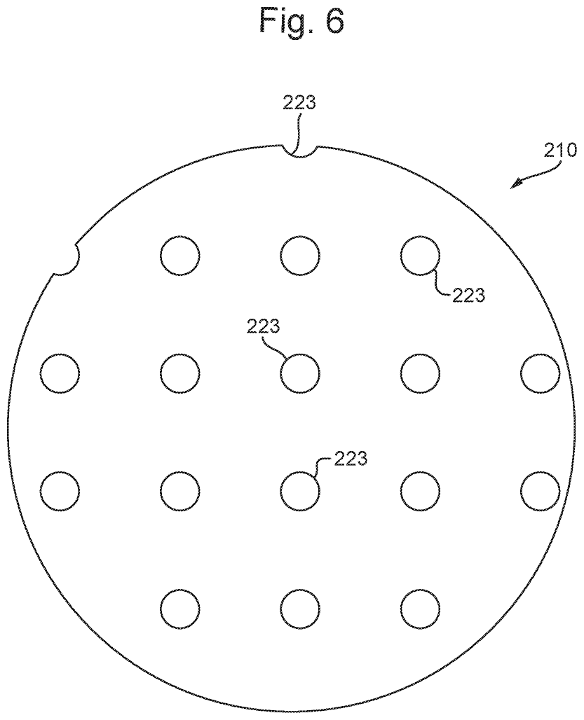

In FIG. 6, yet another example of a screen 210 for a capsule according to the invention is shown. In this example, the passages 223 (not all designated by a reference number) are arranged in a pattern that is uniform over the entire surface area of the screen 210. An advantage of passages arranged according to a uniform pattern is that the screen material can be provided with the passages very efficiently before screens are severed out of the screen material. Then the screens can be cut or otherwise severed out of the patterned screen material.

In this example, the pattern is a uniform pattern of columns and rows at uniform mutual distances. However, also other patterns, such a patterns in which successive rows are mutually staggered in longitudinal direction, e.g. by half of the pitch between successive columns, or a pattern in which the passages are centred on corners of imaginary hexagonal cells.

For effectively distributing water to radially outer portions of the capsule and of the substance 59, it is advantageous if at least some of the passages 73 are arranged at a distance from the centre of more than 40% and more preferably more than 50% or more than 60% of the distance of a peripheral edge from the centre, measured in a direction from the centre to the respective passage. Racially outward water distribution is even further enhanced if this applies to all of the passages.

Radially outward water distribution (which may also be achieved effectively using a screen with a uniform pattern of openings) is particularly relevant if, as for instance in the examples shown in FIGS. 1-3. The capsule body 2, 52 has an internal cross-sectional area along a plane parallel to the cover 7, 57, which is larger at the cover 7, 57 than at the bottom 3, 53. In such a capsule 1, 51, the cross-sectional area increases from the bottom 3, 53 to the cover 7, 57, i.e. in the direction of flow of water through the substance, so that the water will need to distribute over a larger cross-sectional area as it flows through the substance 9, 59. By leading a relatively large portion of the water radially outwardly while incurring only a relatively small pressure loss at the screen, it is ensured that water is also effectively distributed to outer regions of cross-sections of the substance close to the cover 7, 57.

Racially outward water distribution is even more relevant if a shoulder is provided in a side wall of said capsule body, the internal cross-sectional area being larger at a cover side of the shoulder than at a bottom side of the shoulder.

Particularly effective reductions of local flow resistance are achieved if at least some or all of the passages each have a cross-sectional surface area of at least 3 mm², for instance 3-7 mm², more preferably 4-5.5 mm² and/or a cross-sectional size of at least 1-4 mm. The cross-sectional size of the screen may for instance be 20-40 mm, for example 22-30 mm. The diameter of the bottom of the capsule may for instance be 20-40 mm, for example 22-30 mm. The diameter of the screen may be about the same as the diameter of the bottom at the inside of the capsule. The screen may for instance be provided with 4-30 passages, preferably about 15-25 passages. The screen area in which the passages are located may cover 50-100% of the bottom. In a practical embodiment the screen is provided with 15-18 passages each having a diameter of 1.5-2.5 mm, preferably 1.6-2.2 mm, more preferably of 1.6-1.8 mm.

The screen material may for instance have a specific weight of 20-200 g/cm², preferably 40-100 g/cm². The screen material may for instance have a thickness of 0.1-1 mm, preferably 0.2-0.5 mm. The screen material (without the passages) may for instance have an air permeability of 500-3000 l/(m²s) at a pressure drop of 100 Pa over the screen material, preferably between 1000 and 1500 l/(m²s) at a pressure drop of 100 Pa over the screen material. The screen has a surface area that can be regarded as being composed of an inner surface area and an outer surface area surrounding the inner surface area, the inner surface area forming at least 25% of a total surface area of the screen and an inner portion of the passages in the inner surface area provide an open surface area of a first proportion of the inner surface area, while an outer portion of the passages in the outer surface area provides an open surface area of a second proportion of the outer surface area. It is then advantageous for outward water distribution if the second proportion is larger than the first proportion. The inner surface area may for instance constitute at least 40%, 50% or 60% of the total surface area of the screen and the inner surface area may also be free of passages, at least prior to brewing. The inner surface area may have a circular boundary, a centre of the screen forming the centre of the inner surface area.

The screen is preferably of water permeable material (e.g. one or more layers of fibrous material, such as filter paper, felt material or woven material), so that not all of the water flow is concentrated through the passages. However, if the number of passages is sufficiently large and the passages are sufficiently evenly distributed, the screen may also be of water impermeable material.

Several features have been described as part of the same or separate embodiments. However, it will be appreciated that the scope of the invention also includes embodiments having combinations of all or some of these features other than the specific combinations of features embodied in the examples.

1. A capsule comprising:
a capsule body having a bottom, a side wall, an end opposite of the bottom and a flange extending outwardly from the side wall and around the open end; and
a cover attached to the outwardly extending flange, the cover closing off the end of the capsule body opposite of the bottom;
the capsule body and the cover bouncing a capsule chamber, the capsule chamber containing:
a substance constituted by a mass of loose, solid particles, for the preparation of a potable beverage by extracting and/or dissolving the substance by means of supplying a fluid under pressure into the capsule, and
a screen, of a material impermeable to a predominant portion of said particles, said screen being positioned between said substance and said bottom;
characterized in that said screen is provided with a plurality of passages dimensioned so that at least a fraction of the substance can pass through the passages in solid form.

2. A capsule according to claim 1, wherein said passages are arranged in a pattern that is uniform over the full surface of the screen.

3. A capsule according to claim 1 or 2, wherein said screen is attached to said capsule body along attachment zones spaced from the centre and circumferentially spaced from each other.

4. A capsule according to claim 3, wherein all of said attachment zones are distributed closely, and preferably evenly, along a peripheral edge of the screen.

5. A capsule according to claim 3 or 4, wherein spacings in circumferential sense between successive attachment zones leave open at least 30% in circumferential sense of a circumferential zone in which the attachment zones are located.

6. A capsule according to any of the preceding claims, wherein at least some of the passages are provided in the form of indents or recesses in a peripheral edge of the screen.

7. A capsule according to any of the preceding claims, wherein at least some of the passages are provided in the form of openings circumferentially bounded by material of the screen.

8. A capsule according to any of the preceding claims, wherein at least some or all of said passages have a cross-sectional surface area of at least 3.0 mm².

9. A capsule according to any of the preceding claims, wherein at least some or all of said passages have a smallest cross-sectional size of at least 1.0 mm.

10. A capsule according to any of the preceding claims, wherein at least some of said passages are arranged at a distance from the centre of more than 40% and more preferably more than 50% or more than 60% of the distance of a peripheral edge from the centre, measured in a direction from the centre to the respective passage.

11. A capsule according to claim 10, wherein all of said passages are arranged at a distance from the centre of more than 40% and more preferably more than 50% or more than 60% of the distance of a peripheral edge from the centre, measured in a direction from the centre to the respective opening

12. A capsule according to any of the preceding claims, wherein the screen has a surface area including an inner surface area and an outer surface area surrounding the inner surface area, the inner surface area forming at least 25% of a total surface area of the screen, wherein an inner portion of said passages in said inner surface area provide an open surface area of a first proportion of said inner surface area, wherein an outer portion of said passages in said outer surface area provide an open surface area of a second proportion of said outer surface area, and wherein said second proportion is larger than said first proportion.

13. A capsule according to claim 12, wherein said inner surface area forms at least 40% of the total surface area of the screen.

14. A capsule according to claim 12 or 13, wherein said inner surface area is free of said passages.

15. A capsule according to any of the claims 12-14, wherein said inner surface area has a circular boundary, a centre of the screen forming the centre of the inner surface area.

16. A capsule according to any of the preceding claims, wherein the capsule body has an internal cross-sectional area along a plane parallel to the cover, which is larger at the cover than at the bottom.

17. A capsule according to claim 15, wherein a shoulder is provided in a side wall of said capsule body, said internal cross-sectional area being larger at a cover side of said shoulder than at a bottom side of said shoulder.

18. A capsule according to any of the preceding claims, wherein the screen is of water permeable material.

19. A capsule according to claim 17, wherein the screen is of one or more layers of fibrous material, such as filter paper, felt material or woven material.

20. A capsule according to any of the preceding claims, wherein all of the attachment zones where the screen is attached to the capsule are spaced from the centre and circumferentially spaced from each other.

21. A capsule according to any of the preceding claims, wherein the screen is not attached to a centre area of the bottom.

22. A capsule according to any of the preceding claims, wherein the screen is arranged to move away from the centre area of the bottom under influence of piercing elements by means of which, in use, openings are pierced in the bottom of the capsule for injecting fluid into the capsule and/or under influence of fluid injected via openings in the bottom which openings are created by means of a coffee machine wherein the capsule is positioned for brewing coffee.

23. A capsule according to any of the preceding claims, wherein the screen is of circular shape having a diameter of 20-40 mm.

24. A capsule according to any of the preceding claims, wherein the screen covers substantially the entire internal surface area of the bottom of the capsule body.

25. A capsule according to any of the preceding claims, wherein the number of said passages is 4-30.

26. A capsule according to any of the preceding claims, wherein the screen material has a weight of 20-200 g/cm².

27. A capsule according to any of the preceding claims, wherein the screen material without said passages has an air permeability between 500 and 3000 l/(m²s) at a pressure drop of 100 Pa over the screen material.

28. A system comprising a capsule according to any of the preceding claims and a coffee machine, the coffee machine having:
a housing in which a major portion of capsule body can be received;
a closing member with passages for allowing a prepared beverage to flow away from the capsule, the housing and/or the closing member being movable relative to the other between an operating position in which the flange of the capsule is clamped between the housing and the closing member and a transfer position leaving an opening through which a used capsule can be removed from the housing and a fresh capsule can be positioned in the housing;
piercing elements which are arranged for, in use, piercing a bottom portion of the capsule body inside the housing in at least one piercing location; and
a water supply for supplying water to said piercing location and causing the water to enter said capsule via said pierced bottom.

29. A system according to claim 28, wherein at least some of the passages are located peripherally of the at least one piercing location.

30. A method for preparing a beverage using a system according to claim 28 or 29, comprising:
positioning the capsule in a housing and clamped between the housing and a closing member with perforations for allowing brewed beverage outputted through the cover to flow away from the capsule;
feeding pressurised injection fluid such as hot water into the housing, causing the injection fluid to penetrate the capsule through at least one hole in said bottom;
causing the cover to be torn preferably under the influence of fluid pressure in the capsule;
pressing a flow of injection fluid at least partially through the screen, into and through the substance and through the cover so that a brewed beverage exits the capsule; and
guiding the brewed beverage to a receptacle.
